(19) United States
(12) Patent Application Publication
(10) Pub. No.: US 2024/0425019 A1
(43) Pub. Date: Dec. 26, 2024

(54) RETRACTION SPRING AND CALIPER BRAKE INCLUDING THE SAME

(71) Applicant: HL MANDO CORPORATION, Gyeonggi-do (KR)

(72) Inventor: Dongkyun AHN, Seoul (KR)

(21) Appl. No.: 18/614,634

(22) Filed: Mar. 23, 2024

(30) Foreign Application Priority Data
Jun. 22, 2023 (KR) 10-2023-0080542

(51) Int. Cl. B60T 1/06; F16F 1/373; F16F 1/44

(52) U.S. Cl. CPC B60T 1/065; F16F 1/373; F16F 1/44

(57) ABSTRACT

A retraction spring includes a pad coupling part including a first arm and a second arm contacting a front surface and a rear surface of the protruding portion, respectively, and a connecting portion connecting between the first arm and the second arm, a body part extending from the pad coupling part and configured to provide an elastic restoring force, and a carrier support part extending from the body part and supported by a coupling hook formed on a carrier. The first arm is bent at or from one side of the connecting portion toward the front surface, the second arm is bent at or from the other side of the connecting portion toward the rear surface, and the body part is bent from the other side of the connecting portion.

### CROSS-REFERENCE TO RELATED APPLICATION

This application claims the priority to and the benefit of Korean Patent Application No. 10-2023-0080542, filed on Jun. 22, 2023 in the Korean Intellectual Property Office, the disclosure of which is incorporated herein by reference in its entirety.

### BACKGROUND

### 1. Field

Some embodiments of the present disclosure generally relate to a retraction spring and a caliper brake including the same, and more specifically, to a retraction spring capable of preventing a drag phenomenon when braking is released, and a caliper brake including the same.

### 2. Description of the Related Art

A brake system for performing braking is necessarily mounted to vehicles, and various types of brake systems have been developed for the safety of passengers and freights.

One of examples of brake systems is a caliper brake. The caliper brake may be a brake system for generating a braking force by friction or clamping pressure between a brake disk and a brake pad such that and the caliper brake presses the brake pads installed at both sides of the brake disk rotating with a wheel toward the brake disk. The caliper brake may include a caliper covering the brake pad and provided to allow the brake pad to move forward toward and backward from the brake disk, a cylinder and a piston. The caliper brake presses the brake pad toward the brake disk by applying a hydraulic pressure for braking to an inside of the cylinder or moving the piston forward by power of an electric motor.

The brake pad performs the braking by approaching and being in contact with the brake disk or releases the braking by being spaced apart or moving away from the brake disk, and the brake pad is elastically supported by a pad spring. In addition, the caliper brake may include retraction means to return the brake pad to an original position or a brake release position when the braking is released, and this retraction means may be installed to provide an elastic restoring force to the brake pad or a pad plate.

The retraction means may be an essential component for the performance and operational reliability of the caliper brake because it can prevent the drag phenomenon in which the brake disk is in continuous contact with the brake pad even when the braking is released.

### SUMMARY

Therefore, it is an aspect of the present disclosure to provide a retraction spring provided in a separated manner to easily perform a change in structure thereof and a caliper brake including the same.

It is another aspect of the present disclosure to provide a retraction spring with improved restoring force, and a caliper brake including the same.

It is still another aspect of the present disclosure to provide a retraction spring of which material waste can be minimized during the manufacturing of the retraction spring, and a caliper brake including the same.

It is yet another aspect of the present disclosure to provide a retraction spring for easy assembly and maintenance, and a caliper brake including the same.

It is yet another aspect of the present disclosure to provide a retraction spring with improved operational performance and reliability, and a caliper brake including the same.

Additional aspects of the disclosure will be set forth in part in the description which follows and, in part, will be obvious from the description, or may be learned by practice of the disclosure.

In accordance with one aspect of the present disclosure, a retraction spring coupled to protruding portions formed on both sides of a pad plate of a brake pad and configured to return the brake pad in an axial direction when braking is released includes a pad coupling part including a first arm and a second arm that come into contact with a front surface and a rear surface of the protruding portion, respectively, and a connecting portion provided between the first arm and the second arm, a body part extending from the pad coupling part and configured to provide an elastic restoring force, and a carrier support part extending from the body part and supported by a coupling hook formed on a carrier, wherein the first arm is bent at one side of the connecting portion and extends toward the front surface, the second arm is bent at the other side of the connecting portion and extends toward the rear surface, and the body part is provided to extend and be bent from the other side of the connecting portion.

The connecting portion may be provided to face or contact a side surface of the protruding portion.

The connecting portion may be provided to face or contact a lower surface of the protruding portion.

The body part may be formed by being primarily bent toward a center from the pad coupling part and secondarily bent outward.

The body part may be tertiarily bent axially and connected to the carrier support part.

The body part may be formed by being primarily bent upward from the pad coupling part and secondarily bent downward.

The body part may be tertiarily bent axially and connected to the carrier support part.

The first arm may include a first inclined portion bent at one side of the connecting portion and having an inclination approaching the second arm, and a second inclined portion bent from the first inclined portion and having an inclination away from the second arm.

The second arm may include a third inclined portion bent at the other side of the connecting portion and having an inclination approaching the first arm, and a fourth inclined portion bent from the third inclined portion and having an inclination away from the first arm.

A minimum distance among distances between the first arm and the second arm may be provided smaller than a thickness of the protruding portion.

The body part may include at least one opening formed to pass therethrough.

The carrier support part may include a first leg extending from the body part and bent in one direction, and a second leg extending from the body part and bent in the other direction.

The carrier support part may include a first leg extending from the body part and at least partially cut and bent in one direction, and a second leg extending from the body part and bent in the other direction.

The carrier support part may include at least one bent portion extending from and bent on the body part.

A caliper brake includes a pair of brake pads each including a frictional pad provided to press both side surfaces of a disk rotating together with a wheel, and a pad plate to which the frictional pad is attached, a carrier including slide grooves into which protruding portions formed at both sides of the pad plate of each of the brake pads are fitted, and coupling hooks formed around the slide grooves, and a retraction spring coupled to the protruding portion and configured to return the brake pad in an axial direction when braking is released, wherein the retraction spring includes a pad coupling part including a first arm and a second arm that come into contact with a front surface and a rear surface of the protruding portion, respectively, and a connecting portion provided between the first arm and the second arm and provided to face a side surface or lower surface of the protruding portion, a body part extending from the pad coupling part and configured to provide an elastic restoring force, and a carrier support part extending from the body part and supported by the coupling hook, the first arm is bent at one side of the connecting portion and extends toward the front surface, at least a portion of the second arm is bent at the other side of the connecting portion and extends toward the rear surface, and the body part is provided to extend and be bent from the other side of the connecting portion.

The body part may include a first curved portion bent toward a portion corresponding to a center from the pad coupling part, a first flat portion extending from the first curved portion, a second curved portion bent in a direction corresponding to an outward direction from the first flat portion, and a second flat portion extending from the second curved portion.

The body part may further include a third curved portion bent in a direction corresponding to an axial direction from the second flat portion, and a third flat portion extending from the third curved portion and connected to the carrier support part.

The body part may include a first curved portion bent in a direction corresponding to an upward direction from the pad coupling part, a first flat portion extending from the first curved portion, a second curved portion bent in a direction corresponding to a downward direction from the first flat portion, and a second flat portion extending from the second curved portion.

The body part may further include a third curved portion bent in a direction corresponding to an axial direction from the second flat portion, and a third flat portion extending from the third curved portion and connected to the carrier support part.

The carrier may be provided so that a distance from the disk to the coupling hook onto which a protruding portion of an inner brake pad is fitted differs from a distance from the disk to the coupling hook onto which a protruding portion of an outer brake pad is fitted.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view schematically illustrating a caliper brake according to a first embodiment of the present disclosure;

FIG. 2 is a front view schematically illustrating the caliper brake according to the first embodiment of the present disclosure;

FIG. 3 is a perspective view schematically illustrating a retraction spring according to the first embodiment of the present disclosure;

FIG. 4 is a cross-sectional view illustrating the caliper brake equipped with the retraction spring according to the first embodiment of the present disclosure;

FIG. 5 is a plan view schematically illustrating the caliper brake according to the first embodiment of the present disclosure;

FIG. 6 is a front view schematically illustrating a caliper brake according to a second embodiment of the present disclosure;

FIG. 7 is a perspective view schematically illustrating a retraction spring according to the second embodiment of the present disclosure;

FIG. 8 is a plan view schematically illustrating the retraction spring according to the second embodiment of the present disclosure;

FIG. 9 is a perspective view schematically illustrating a retraction spring according to a third embodiment of the present disclosure;

FIG. 10 is a plan view schematically illustrating the retraction spring according to the third embodiment of the present disclosure;

FIG. 11 is a perspective view schematically illustrating a retraction spring according to a fourth embodiment of the present disclosure;

FIG. 12 is a plan view schematically illustrating the retraction spring according to the fourth embodiment of the present disclosure;

FIG. 13 is a perspective view schematically illustrating a retraction spring according to a fifth embodiment of the present disclosure;

FIG. 14 is a plan view schematically illustrating the retraction spring according to the fifth embodiment of the present disclosure;

FIG. 15 is a perspective view schematically illustrating a retraction spring according to a sixth embodiment of the present disclosure; and

FIG. 16 is a plan view schematically illustrating the retraction spring according to the sixth embodiment of the present disclosure.

### DETAILED DESCRIPTION

Hereinafter, embodiments of the present disclosure will be described in detail with reference to the accompanying drawings. The following embodiments are presented to sufficiently convey the spirit of the present disclosure to those skilled in the art to which the present disclosure pertains. The present disclosure may also be specified in other forms without being limited to only the embodiments presented herein. In the drawings, in order to clarify the present disclosure, illustration of parts irrelevant to the description may be omitted, and the sizes of components may be slightly exaggerated to help understanding.

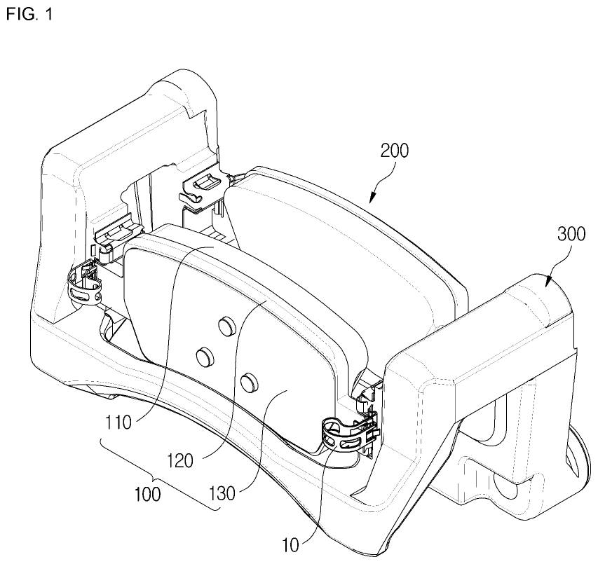

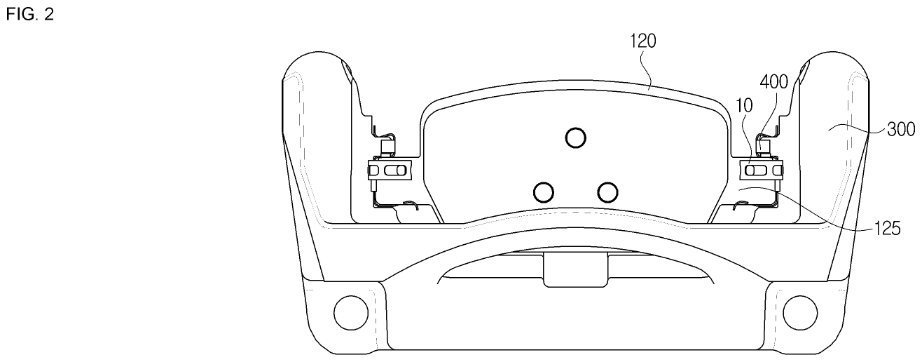

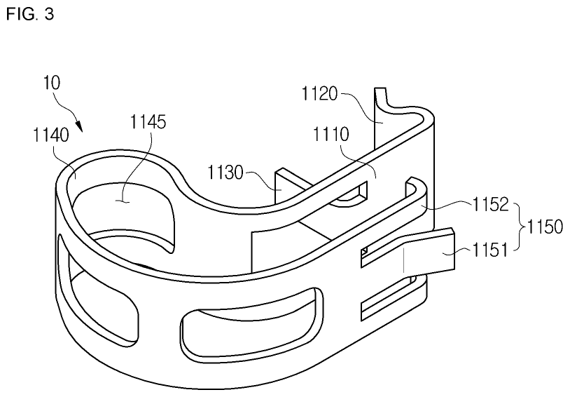

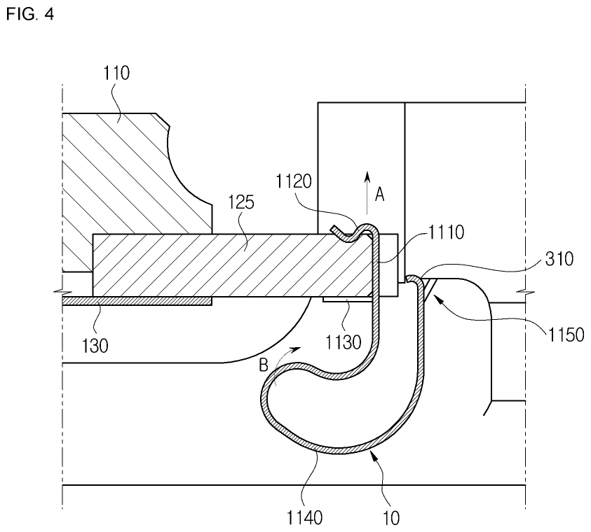

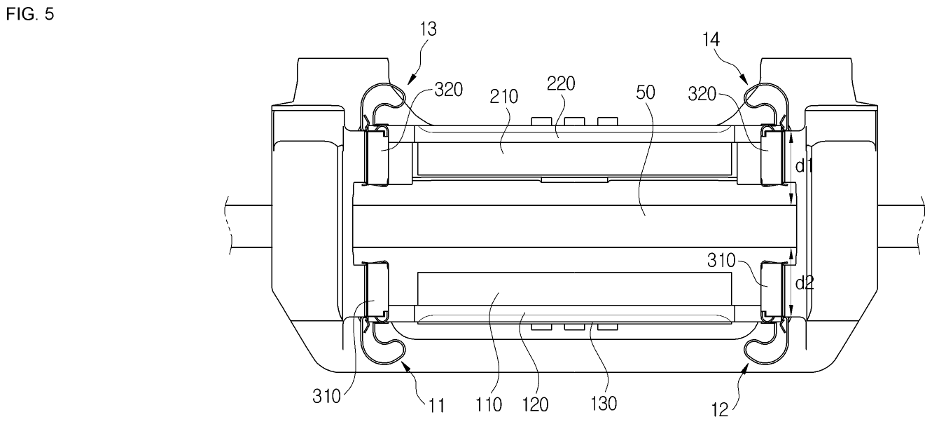

FIG. 1 is a perspective view schematically illustrating a caliper brake according to a first embodiment of the present disclosure, and FIG. 2 is a front view schematically illustrating a caliper brake according to the first embodiment of the present disclosure. In addition, FIG. 3 is a perspective view schematically illustrating a retraction spring according to the first embodiment of the present disclosure, and FIGS. 4 and 5 are a partial cross-sectional view and a plan view illustrating a caliper brake equipped with the retraction spring according to the first embodiment of the present disclosure, respectively.

Referring to FIGS. 1 to 5, the caliper brake according to an embodiment of the present disclosure may include a pair of brake pads 100 and 200, a carrier 300, a caliper housing, and a retraction spring 10. The brake pads 100 and 200 may include pad plates 120 and 220 to which frictional pads 110 and 210 are attached so as to press both side surfaces of a disk 50 rotating with a wheel. The carrier 300 may have slide grooves into which protruding portions 125 formed at both sides of the pad plates 120 and 220 of each of the brake pads 100 and 200 are movably or slidably fitted or inserted so that the pair of brake pads 100 and 200 can move forward toward or backward away from the disk 50 and coupling hooks 310 formed around the slide grooves. The caliper housing is slidably mounted on the carrier 300 and operates the pair of pad plates 120 and 220. The retraction spring 10 is coupled to the protruding portions 125 of the pair of brake pads 100 and 200 and is configured to return the brake pads 100 and 200 to their original position or brake release position in an axial direction when the braking is released.

The frictional pads 110 and 210 that cause friction against the disk 50 are respectively attached to inner surfaces of the pair of brake pads 100 and 200, and the protruding portions 125 are formed on both end portions or side portions of each of the pad plates 120 and 220. The pair of brake pads comprises an outer brake pad 100 disposed in contact with or in association with a finger portion of a caliper and an inner brake pad 200 disposed in contact with or in association with a piston. Shims 130 may be provided on outer surfaces of the brake pads 100 and 200.

The carrier 300 is fixedly coupled to a fixture of a vehicle such as a knuckle of a vehicle body to be positioned adjacent to an outer circumference of the disk 50. The slide grooves are formed in both inner side portions of the carrier 300 at positions corresponding to the protruding portions 125 formed on both side surfaces of the pad plates 120 and 220 of the pair of brake pads 100 and 200, and the coupling hooks 310 are formed around the slide grooves. A pair of coupling hooks 310 are formed on both inner side portions of the carrier 300, and therefore the carrier 300 may have a total of four coupling hooks 310.

Guide holes are formed to be parallel to the slide grooves in or at both upper side portions of the carrier 300. the slide grooves may be each formed at the front and rear of the carrier 300 so that the pair of brake pads 100 and 200 are each installed therein. In other words, as illustrated in FIGS. 1 and 2, the slide grooves formed in or at both side portions of the carrier 300 are formed to be spaced a certain interval apart or from each other, and the slide groove has an open central portion so that the disk 50 is rotatably positioned by being smoothly inserted therein. In addition, an outer beam and a main beam are formed under the slide grooves at the front and rear of the carrier 300, respectively, to withstand a torque generated during a braking operation.

The protruding portions 125 are coupled by being movably or slidably fitted or inserted into the slide grooves of the carrier 300 so that the pair of brake pads 100 and 200 can slide along the slide grooves of the carrier 300. In other words, when each of the brake pads 100 and 200 moves forward or backward along the slide groove of the carrier 300, each of the frictional pads 110 and 210 is in close contact with both side surfaces of the disk 50 to generate a braking force or is moved away from the disk 50 to release the braking force.

The caliper housing is slidably installed in the carrier 300 as guide rods installed on both ends of the caliper housing are inserted into guide holes provided in or at both ends of the carrier 300. The caliper housing includes a cylinder in or on which the piston for pressing the inner brake pad 200 is installed to move forward or backward and a finger portion for pressing the outer brake pad 100.

A pad spring 400 may be coupled to the slide groove of the carrier 300. The pad spring 400 may allow the protruding portion 125 of the pad plate 120, 220 coupled to the slide groove of the carrier 300 to elastically support the slide movement of the protruding portion 125 along the slide groove. The retraction spring 10 may be installed together with the pad spring 400.

The retraction spring 10 is coupled to the protruding portions 125 of the pair of brake pads 100 and 200 and is configured to return the brake pads 100 and 200 in the axial direction when the braking is released. In other words, four retraction springs 10 may be coupled to the protruding portions 125 formed at both sides of the pad plates 120 and 220 of the pair of brake pads 100 and 200 to return the brake pads 110 and 210 to their original positions or brake release positions in the axial direction when the braking is released.

Referring to FIG. 3, the retraction spring 10 according to the first embodiment of the present disclosure may include a pad coupling part, a body part 1140, and a carrier support part 1150. The pad coupling part may include a first arm 1120 and a second arm 1130 contacting or coupled with a front surface and a rear surface of the protruding portion 125 of the brake pad 100, 200, respectively, and a connecting portion 1110 facing or contacting a side surface of the protruding portion 125 of the brake pad 100, 200. The body part 1140 may extend from the pad coupling part and may be configured to provide an elastic restoring force. The carrier support part 1150 may extend from the body part 1140 and may be supported by the coupling hook 310.

Referring to FIGS. 3 and 4, the first arm 1120 of the retraction spring 10 is bent at or from one side or end of the connecting portion 1110 and extends toward the protruding portion 125 or the brake pad 100, 200, and at least a portion of the second arm 1130 is cut and bent at or from the other side or end of the connecting portion 1110 and extends toward the protruding portion 125 or the brake pad 100, 200. The first arm 1120 and the second art 1130 may extend in a direction substantially parallel to the protruding portion 125 or the brake pad 100, 200 and/or substantially perpendicular to the connecting portion 1110 of the retraction spring 10.

In other words, the first arm 1120 and the second arm 1130 may each have a “⊂” shape bent and extending toward the protruding portion 125 at or from both sides of the connecting portion 1110 formed between the first arm 1120 and the second arm 1130. Referring to FIG. 4, the first arm 1120 of the retraction spring 10 may be in contact with or coupled to a front surface of the protruding portion 125, that is, an inner surface of the protruding portion 125 facing the disk 50, the second arm 1130 of the retraction spring 10 may be in contact with or coupled to a rear surface of the protruding portion 125, that is, an outer surface of the protruding portion 125 positioned farther from the disk 50 than the first arm 1120, and the connecting portion 1110 may face or contact a side surface of the protruding portion 125. The connecting portion 1110 connects between the first arm 1120 and the second arm 1130. The first arm 1120 may be formed to be bent at or from one side or one end of the connecting portion 1110 and extend toward the front surface of the protruding portion 125 to support or face the front surface of the protruding portion 125, and the second arm 1130 may be formed by cutting and bending at least a portion of at the other side of the connecting portion 1110 and extend toward the rear surface of the protruding portion 125 to support or face the rear surface of the protruding portion 125. In addition, the body part 1140 is connected to and formed to extend from the other side of the connecting portion 1110.

Referring to FIG. 4, in the first embodiment of the present disclosure, the first arm 1120 may have a curved shape including a first inclined portion bent at or from one side or one end of the connecting portion 1110 toward the second arm 1130 and having an inclination approaching the second arm 1130 and a second inclined portion bent away from the second arm 1130 and having an inclination away from the second arm 1130. In other words, the first arm 1120 may have a shape in which a connecting portion of the first inclined portion and the second inclined portion of the first arm 1120 protrudes toward the second arm 1130. In this case, the closest distance between the first arm 1120 and the second arm 1130 may be provided narrower or smaller than a thickness of the protruding portion 125 in a state that the retraction spring 10 is not coupled to the protruding portion 125 of the brake pad 100, 200, and thus, when the protruding portion 125 is inserted between the first arm 1120 and the second arm 1130, the first inclined portion and the second inclined portion of the first arm 1120 can be elastically deformed, and thus the protruding portion 125 may be stably or firmly placed or coupled between the first arm 1120 and the second arm 1130 by their elastic restoring force.

The body part 1140 may be connected to and formed to extend from the other side or end of the connecting portion 1110.

The body part 1140 may be bent to have a substantially continuously curved shape, of which one end is connected to and extends from the pad coupling part and the other end is connected and extends to the carrier support part 1150. The body parts 1140 is configured to return the brake pads 100 and 200 when the braking is released by generating the elastic restoring forces when the brake pads 100 and 200 slide along the slide grooves of the carrier 300 in a state in which the carrier support parts 1150 are supported by the coupling hooks formed around the slide grooves of the carrier 300 and the pad coupling parts are coupled to the protruding portions 125 of the brake pads 100 and 200. For example, referring to FIG. 4, when the brake pad 100 slides in a direction A during the braking, the body part 1140 is elastically deformed in a direction B, and when the braking is released, the brake pad 100 is returned to its original position by the elastic restoring force of the body part 1140.

The body part 1140 may have a bent shape to provide an appropriate elastic restoring force to the brake pad 100.

The body part 1140 may be primarily bent toward a center (e.g. a center of the brake pad 100) or a portion corresponding to the center from the pad coupling part, secondarily bent outward (e.g. in a direction of being away from the center of the brake pad 100) or in a direction corresponding to the outward direction, and tertiarily bent in an axial direction (e.g. in a direction perpendicular to the brake pad 100) or a direction corresponding to the axial direction to be connected and extend to the carrier support part 1150. In addition, at least a portion of the body part 1140 may be formed to extend flat between the bent portions. The body part 1140 may have one or more openings 1145 formed to pass therethrough. The opening 1145 may be formed to pass through the bent band-shaped body part 1140, and a magnitude or strength of the elastic restoring force which can be generated by the body part 1140 may be adjusted by varying the number and sizes of the openings 1145. The opening 1145 may be provided as a plurality of openings, and the plurality of openings 1145 may be disposed to be spaced a certain distance apart or from each other in a horizontal direction of the body part 1140.

The carrier support part 1150 is supported by the coupling hook 310, 320 formed on the carrier 300. The carrier support part 1150 may include a first leg 1151 extending from the body part 1140 and bent in one direction and a second leg 1152 extending from the body part 1140 and bent in the other direction. As illustrated in FIG. 3, at least a portion of the first leg 1151 of the carrier support part 1150 may be provided by cutting and bending a portion of the carrier support part 1150 in one direction, and the second leg 1152 of the carrier support part 1150 may be provided by bending another portion of the carrier support part 1150 in the other direction. As described above, by manufacturing the first leg 1151 and the second leg 1152 by cutting between the first leg 1151 and the second leg 1152 and bending the first leg 1151 and the second leg 1152 in different directions, material waste may be reduced and the stable support of the retraction spring 10 on the carrier 300 may be achieved.

As described above, since the retraction spring 10 according to the first embodiment of the present disclosure may include the pad coupling part, the body part 1140, and the carrier support part 1150 formed by being cut and/or bent, material waste may be reduced during the manufacturing of the retraction spring 10 and a process of manufacturing the retraction spring 10 may be simplified. The caliper brake according to the first embodiment of the present disclosure may differently set or adjust restoring forces applied to the inner brake pad 200 and the outer brake pad 100 without changing the retraction spring 10. The inner brake pad 200 may be directly or indirectly pressed by the piston, and the outer brake pad 100 is pressed according to an operation of the finger portion of the caliper housing by a reaction force. Therefore, different restoring forces for returning the brake pads 100 and 200 may be required when the braking is released. In order to differently set or provide the restoring forces applied to the outer brake pad 100 and the inner brake pad 200, the carrier 300 of the caliper brake according to the first embodiment of the present disclosure may have asymmetric positions of the coupling hooks 310 and 320.

Specifically, referring to FIG. 5, the pair of brake pads 100 and 200 are coupled to the carrier 300 to press both side surfaces of the disk 50, and the outer brake pad 100 is coupled by fitting the protruding portions 125 of the outer brake pad 100 into the outer slide grooves of the carrier 300 to press an outer surface of the disk 50.

Retraction springs 11 to 14 illustrated in FIG. 5 may be implemented by the embodiment of the retraction spring 10 described above. Each of retraction springs 11 and 12 is coupled to a respective one of the protruding portions 125 formed at both sides of the outer brake pad 100. In addition, the inner brake pad 200 is coupled by movably or slidably fitting or inserting the protruding portions 125 into the inner slide grooves of the carrier 300 to press or move away from an inner surface of the disk 50. Each of retraction springs 13 and 14 may be coupled to a respective one of the protruding portions 125 formed at both sides of the inner brake pad 200, and the retraction springs 11 and 12 coupled to the outer brake pad 100 and the retraction springs 13 and 14 coupled to the inner brake pad 200 may be provided as the same retraction spring 10. In this case, the carrier 300 may be provided such that a distance from the disk 50 to the coupling hook 310 onto which the outer brake pad 100 is fitted differs from a distance from the disk 50 to the coupling hook 320 onto which the inner brake pad 200 is fitted. As described above, one side of the retraction spring 10 is coupled to the protruding portions 125 of the brake pads 100 and 200, and the other side of the retraction spring 10 is supported by the coupling hooks 310 and 320 of the carrier 300. In this case, when the coupling hook 320 is relatively far from the disk 50, even when the brake pad 200 is positioned at the same position, the deformation of the body part 1140 is relatively large and thus pre-loading may be applied, and as a result, a relatively large restoring force is applied to the brake pad 200. Conversely, when the coupling hook 320 is relatively close to the disk 50, even when the brake pad 100 is positioned at the same position, the deformation of the body part 1140 is relatively small, and thus a relatively small restoring force is applied to the brake pad 100. Specifically, referring to FIG. 5, each of the elastic restoring forces applied to the outer brake pad 100 and the inner brake pad 200 is determined depending on a distance d2 from the disk 50 to the coupling hook 310 around the slide groove to which the outer brake pad 100 is coupled and a distance d1 from the disk 50 to the coupling hook 320 around the slide groove to which the inner brake pad 200 is coupled. As illustrated in FIG. 5, as the distance d1 to the coupling hook 320 around the slide groove to which the inner brake pad 200 is coupled is provided larger than the distance d2 to the coupling hook 310 around the slide groove to which the outer brake pad 100 is coupled, the body part 1140 of the retraction spring 10 provided at the inner brake pad 200 side may have larger deformation during the braking operation, and therefore the inner brake pad 200 may have a larger restoring force than the outer brake pad 100, and thus it may be possible to prevent uneven wear of the brake pads 100 and 200 and implement a stable braking operation.

Hereinafter, a retraction spring and a caliper brake having the same according to a second embodiment of the present disclosure will be described.

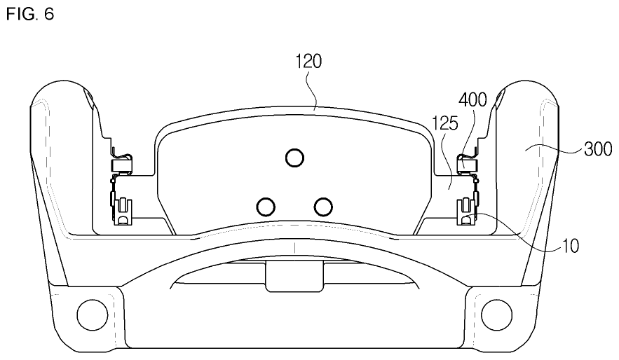

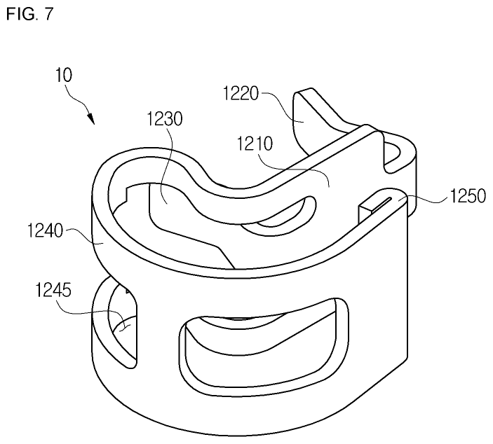

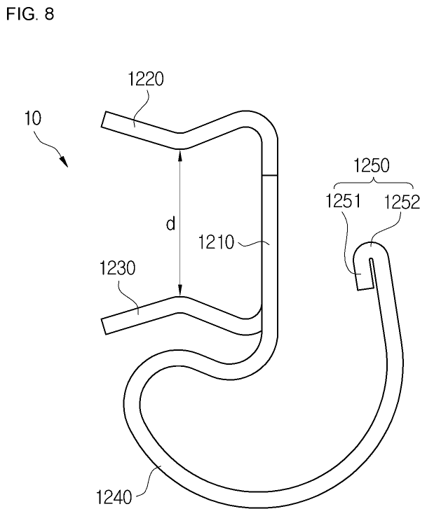

FIG. 6 is a front view schematically illustrating a caliper brake according to a second embodiment of the present disclosure. In addition, FIGS. 7 and 8 are a perspective view and a plan view illustrating a retraction spring according to the second embodiment of the present disclosure.

Referring to FIGS. 6 to 8, a retraction spring 10 according to the second embodiment of the present disclosure may be provided such that a connecting portion 1210 of a pad coupling part faces or contacts a lower surface of the protruding portion 125 of the brake pad 100, 200.

The following description of the second embodiment of the present disclosure other than an additional description is the same as or similar to the above description of the first embodiment of the present disclosure and thus will be omitted to prevent overlapping contents.

Referring to FIGS. 6 to 8, the retraction spring 10 according to the second embodiment of the present disclosure may include a pad coupling part, a body part 1240, and a carrier support part 1250. The pad coupling part may comprise a connecting portion 1210, a first arm 1220, and a second arm 1230.

The first arm 1220 according to the second embodiment may be bent at or from one side or end of the connecting portion 1210 and may extend toward the protruding portion 125 or the brake pad 100, 200, and at least a portion of the second arm 1230 may be cut and bent at or from the other side or end of the connecting portion 1210 and may extend toward the protruding portion 125 or the brake pad 100, 200. The first arm 1220 and the second art 1230 may extend in a direction substantially parallel to the protruding portion 125 or the brake pad 100, 200 and/or substantially perpendicular to the connecting portion 1210 of the retraction spring 10. In addition, the body part 1240 to be described below is connected to and formed to extend from the other side or end of the connecting portion 1210.

The first arm 1220 may have a curved shape including a first inclined portion bent at or from one side or end of the connecting portion 1210 toward the second arm 1230 and having an inclination approaching the second arm 1230 and a second inclined portion bent away from the second arm 1230 and having an inclination away from the second arm 1230. The second arm 1230 may have a curved shape including a third inclined portion bent at or from the other side or end of the connecting portion 1210 toward the first arm 1220 and having an inclination approaching the first arm 1220 and a fourth inclined portion bent away from the first arm 1230 having an inclination away from the first arm 1220. In other words, the first arm 1220 may have a shape in which a connecting portion of the first inclined portion and the second inclined portion of the first arm 1220 protrudes toward the second arm 1230, the second arm 1230 may have a shape in which a connecting portion of the third inclined portion and the fourth inclined portion of the second arm 1230 protrudes toward the first arm 1220, and the protruded connecting portions of the first arm 1220 and the second arm 1230 may be provided at positions facing or corresponding to each other to be securely or firmly coupled to the protruding portions 125 of the brake pad 100, 200 inserted between the first arm 1220 and the second arm 1230. In this case, the closest distance d between the first arm 1220 and the second arm 1230 may be provided narrower or smaller than a thickness of the protruding portion 125 in a state that the retraction spring 10 is not coupled to the protruding portion 125 of the brake pad 100, 200, and thus, when the protruding portion 125 is inserted between the first arm 1220 and the second arm 1230, the first to fourth inclined portions can be elastically deformed, and thus the protruding portion 125 may be stably or firmly placed or coupled between the first arm 1220 and the second arm 1230 by their elastic restoring force.

The body part 1240 may be connected to and formed to extend from the other side or end of the connecting portion 1210. In the second embodiment, the body part 1240 may be bent to have a substantially continuously curved shape, of which one end is connected to and extends from the pad coupling part and the other end is connected and extends to the carrier support part 1250. Specifically, the body part 1240 may be primarily bent upward or in a direction corresponding to the upward direction from the pad coupling part, secondarily bent downward or in a direction corresponding to the downward direction, and tertiarily bent in an axial direction or a direction corresponding to the axial direction to be connected and extend to the carrier support part 1250.

In addition, the body part 1240 may have one or more openings 1245 formed to pass therethrough. The opening 1245 may be formed to pass through the bent band-shaped body part 1240, and a magnitude or strength of the elastic restoring force which can be generated by the body part 1240 may be adjusted by varying the number and sizes of the openings 1245. The opening 1245 may be provided as a plurality of openings, and the plurality of openings 1245 may be disposed to be spaced a certain distance apart or from each other in a horizontal direction of the body part 1240.

The carrier support part 1250 may include a bent portion 1252 bent in a direction opposite to a direction in which an end portion of the body part 1240 extends and an extension 1251 extending from the bent portion 1252. In other words, the bent portion 1252 and the extension 1251 may be formed in a substantially “U”-shaped cross-sectional shape so that an outer end portion of the bent portion 1252 may be in contact with and supported by the carrier 300.

Hereinafter, a retraction spring according to a third embodiment of the present disclosure will be described.

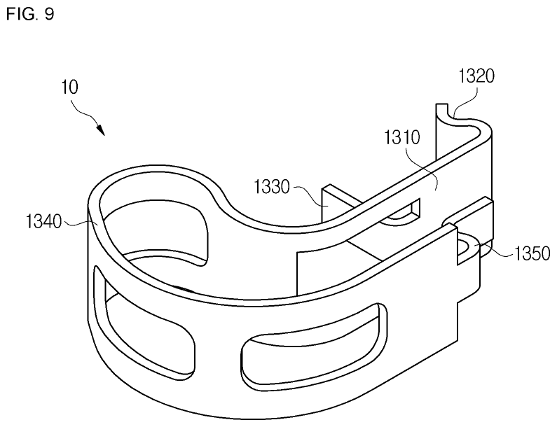

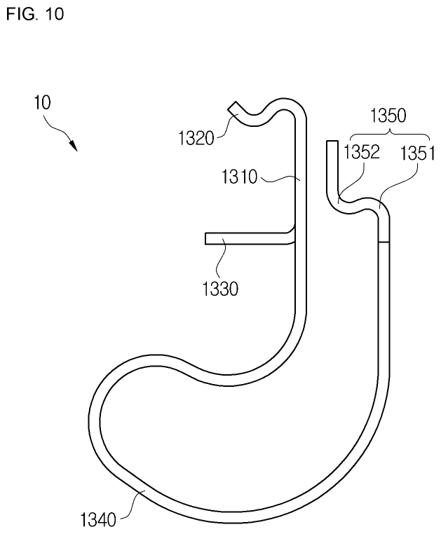

FIGS. 9 and 10 are a perspective view and a plan view illustrating a retraction spring according to the third embodiment of the present disclosure.

Referring to FIGS. 9 and 10, the retraction spring 10 according to the third embodiment may include a pad coupling part, a body part 1340, and a carrier support part 1350. The pad coupling part may include a connecting portion 1310, a first arm 1320, and a second arm 1330

The following description of the third embodiment of the present disclosure other than an additional description is the same as or similar to the above description of the first and second embodiments of the present disclosure and thus will be omitted to prevent overlapping contents.

Referring to FIGS. 9 and 10, the carrier support part 1350 according to the third embodiment may include a first bent portion 1351 extending from an end of the body part 1340 and bent toward the pad coupling part and a second bent portion 1352 extending from the first bent portion 1351 and bent in a direction substantially opposite to, or different from, the first bent portion 1351. In other words, the first bent portion 1351 and the second bent portion 1352 may be bent in substantially opposite or different directions to form a zigzag shape. A substantially stepped shape or portion may be formed by the first bent portion 1351 and the second bent portion 1352 forming the zigzag shape, and the coupling hook 310 of the carrier 300 may be supported by being contacted with the stepped portion of the carrier support part 1350.

A width of the carrier support part 1350 may be narrower or smaller than a width of the body part 1340. Therefore, even when a space in the coupling hook 310 of the carrier 300 is small or narrow, the carrier support part 1350 of the retraction spring 10 may be easily coupled to or contacted with and seated on the coupling hook 310 to stably support the retraction spring 10.

Hereinafter, a retraction spring according to a fourth embodiment of the present disclosure will be described.

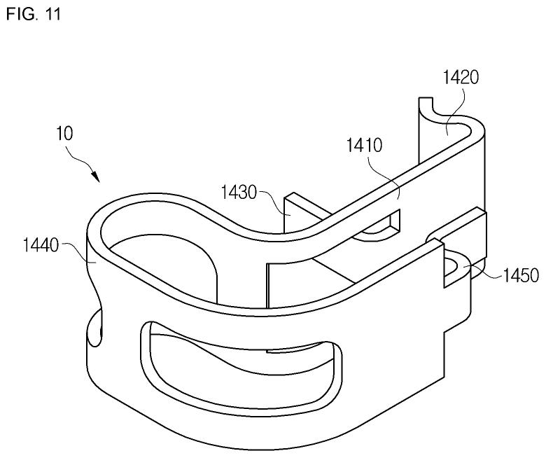

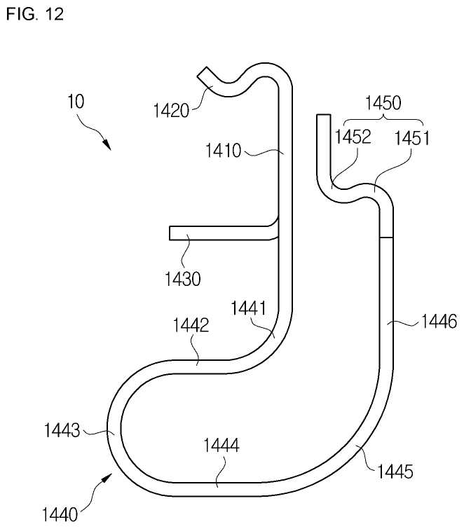

FIGS. 11 and 12 are a perspective view and a plan view illustrating a retraction spring according to the fourth embodiment of the present disclosure.

Referring to FIGS. 11 and 12, the retraction spring 10 according to the fourth embodiment includes a pad coupling part, a body part 1440, and a carrier support part 1450. The pad coupling part may include a connecting portion 1410, a first arm 1420, and a second arm 1430

The following description of the fourth embodiment of the present disclosure other than an additional description is the same as or similar to the above description of the first to third embodiments of the present disclosure and thus will be omitted to prevent overlapping contents.

Referring to FIGS. 11 and 12, the body part 1440 according to the fourth embodiment may be bent to have a plurality of flat portions from the pad coupling part to the carrier support part 1450 and one or more curved portions connecting the plurality of flat portions.

The body part 1440 may include a first curved portion 1441, a first flat portion 1442, a second curved portion 1443, a second flat portion 1444, a third curved portion 1445, and a third flat portion 1446.

In one example in which the connecting portion 1410 is disposed to face or contact a side surface of the protruding portion 125 of the brake pad 100, 200, the first curved portion 1441 is bent toward a center (e.g. a center of the brake pad 100) from the pad coupling part, the first flat portion 1442 extends from the first curved portion 1441, the second curved portion 1443 is bent outward (e.g. in a direction of being away from the center of the brake pad 100) from the first flat portion 1442, the second flat portion 1444 extends from the second curved portion 1443, the third curved portion 1445 is bent axially (e.g. in a direction perpendicular to the brake pad 100) from the second flat portion 1444 and faces the carrier 300, and the third flat portion 1446 extends from the third curved portion 1445 to the carrier support part 1450.

In another example in which the connecting portion 1410 is disposed to face or contact a lower surface of the protruding portion 125 of the brake pad 100, 200, the first curved portion 1441 is bent upward from the pad coupling part, the first flat portion 1442 extends from the first curved portion 1441, the second curved portion 1443 is bent downward from the first flat portion 1442, the second flat portion 1444 extends from the second curved portion 1443, the third curved portion 1445 is bent axially from the second flat portion 1444 and faces the carrier 300, and the third flat portion 1446 extends from the third curved portion 1445 to the carrier support part 1450.

Hereinafter, a retraction spring according to a fifth embodiment of the present disclosure will be described.

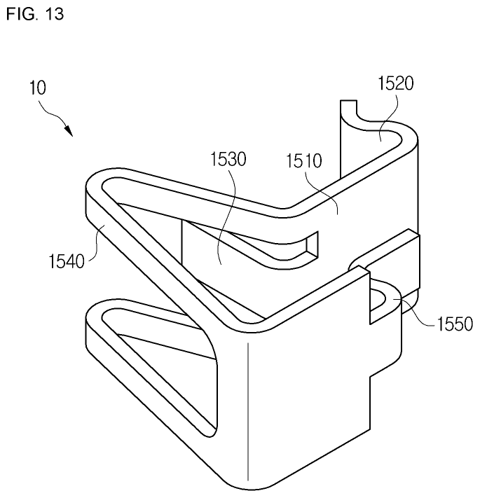

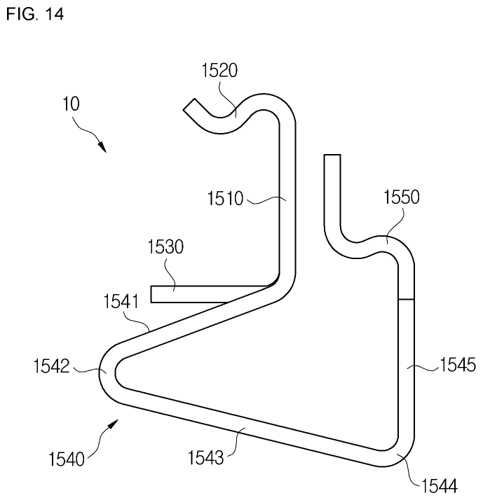

FIGS. 13 and 14 are a perspective view and a plan view illustrating a retraction spring according to the fifth embodiment of the present disclosure.

Referring to FIGS. 13 and 14, a retraction spring 10 according to the fifth embodiment may include a pad coupling part, a body part 1540, and a carrier support part 1550. The pad coupling part may include a connecting portion 1510, a first arm 1520, and a second arm 1530

The following description of the fifth embodiment of the present disclosure other than an additional description is the same as or similar to the above description of the first to fourth embodiments of the present disclosure and thus will be omitted to prevent overlapping contents.

Referring to FIGS. 13 and 14, the body part 1540 according to the fifth embodiment may be bent to have a plurality of flat portions from the pad coupling part to the carrier support part 1550 and one or more curved portions connecting the plurality of flat portions.

The body part 1540 may include a first flat portion 1541, a first curved portion 1542, a second flat portion 1543, a second curved portion 1544, and a third flat portion 1545.

In one example in which the connecting portion 1510 is disposed to face or contact the side surface of the protruding portion 125 of the brake pad 100, 200, the first flat portion 1541 extends toward a portion corresponding to a center (e.g. a center of the brake pad 100) from the pad coupling part, the first curved portion 1542 is bent in a direction corresponding to the outward direction (e.g. in a direction of being away from the center of the brake pad 100) from the first flat portion 1541, the second flat portion 1543 extends from the first curved portion 1542, the second curved portion 1544 is bent axially (e.g. in a direction perpendicular to the brake pad 100) from the second flat portion 1543 and faces the carrier 300, and the third flat portion 1545 extends from the second curved portion 1544 to the carrier support part 1550, and thus a cross-sectional shape of the body part 1540 may be a triangle with rounded corners.

In another example in which the connecting portion 1510 is disposed to face or contact the lower surface of the protruding portion 125 of the brake pad 100, 200, the first flat portion 1541 is bent and extends in a direction corresponding to the upward direction from the pad coupling part, the first curved portion 1542 is bent in a direction corresponding to the downward direction from the first flat portion 1541, the second flat portion 1543 extends from the first curved portion 1542, the second curved portion 1544 is bent axially from the second flat portion 1543 and faces the carrier 300, and the third flat portion 1545 extends from the second curved portion 1544 to the carrier support part 1550.

Hereinafter, a retraction spring according to a sixth embodiment of the present disclosure will be described.

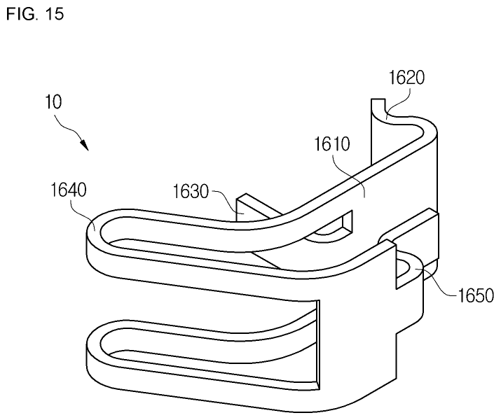

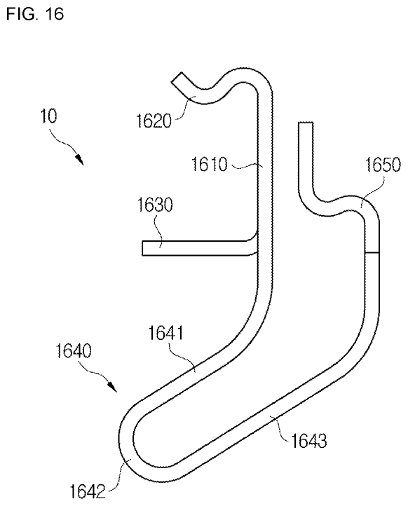

FIGS. 15 and 16 are a perspective view and a plan view illustrating a retraction spring according to the sixth embodiment of the present disclosure.

Referring to FIGS. 15 and 16, the retraction spring 10 according to the sixth embodiment includes a pad coupling part, a body part 1640, and a carrier support part 1650. The pad coupling part may include a connecting portion 1610, a first arm 1620, and a second arm 1630

The following description of the sixth embodiment of the present disclosure other than an additional description is the same as or similar to the above description of the first to fifth embodiments of the present disclosure and thus will be omitted to prevent overlapping contents.

Referring to FIGS. 15 and 16, the body part 1640 according to the sixth embodiment may be bent to have a plurality of flat portions from the pad coupling part to the carrier support part 1650 and one or more curved portions connecting the plurality of flat portions.

The body part 1640 may include a first flat portion 1641, a first curved portion 1642, and a second flat portion 1643.

In one example in which the connecting portion 1610 is disposed to face or contact the side surface of the protruding portion 125 of the brake pad 100, the first flat portion 1641 is bent and extends to a portion corresponding to a center (e.g. a center of the brake pad 100) from the pad coupling part, the first curved portion 1642 is bent in a direction corresponding to the outward direction (e.g. in a direction of being away from the center of the brake pad 100) from the first flat portion 1641, and the second flat portion 1643 extends from the first curved portion 1642 and the carrier support part 1650 is bent axially (e.g. in a direction substantially perpendicular to the brake pad 100) from the second flat portion 1643 to face the carrier 300. As illustrated in FIG. 16, the first flat portion 1641 and the second flat portion 1643 may be disposed substantially parallel to each other in a cross section of the body part 1640.

In another example in which the connecting portion 1610 is disposed to face or contact the lower surface of the protruding portion 125 of the brake pad 100, the first flat portion 1641 is bent and extends in a direction corresponding to the upward direction from the pad coupling part, the first curved portion 1642 is bent in a direction corresponding to the downward direction from the first flat portion 1641, and the second flat portion 1643 extends from the first curved portion 1642 and the carrier support part 1650 is bent axially from the second flat portion 1643 to face the carrier 300. As illustrated in FIG. 16, the first flat portion 1641 and the second flat portion 1643 may be disposed substantially parallel to each other in the cross section of the body part 1640.

As is apparent from the above description, in a retraction spring according to some embodiments of the present disclosure and a caliper brake including the same, the retraction spring can be provided in a separated manner, and therefore it is possible to easily perform a change or adjustment in structure of the retraction spring.

In a retraction spring according to certain embodiments of the present disclosure and a caliper brake including the same, it is possible to improve braking performance with an excellent restoring force.

In a retraction spring according to some embodiments of the present disclosure and a caliper brake including the same, it is possible to minimize material waste during the manufacturing of the retraction spring and reduce the manufacture cost of the retraction spring.

In a retraction spring according to certain embodiments of the present disclosure and a caliper brake including the same, it is possible to improve assemblability of the retraction spring to a caliper brake and achieve easy maintenance of the retraction spring.

In a retraction spring according to some embodiments of the present disclosure and a caliper brake including the same, it is possible to improve operational performance and product reliability of a caliper brake.

What is claimed is:

1. A retraction spring comprising:
a pad coupling part to be coupled to a protruded portion of a brake pad, the pad coupling part including a first arm and a second arm supporting a front surface and a rear surface of the protruded portion of the brake pad, respectively, and a connecting portion connecting between the first arm and the second arm;
a body part extending from the pad coupling part and configured to provide an elastic restoring force; and
a carrier support part extending from the body part and supported by a coupling hook formed on a carrier to which the brake pad is movably mounted,
wherein:
the first arm of the pad coupling part is bent from one side of the connecting portion toward the front surface of the protruded portion of the brake pad,
the second arm of the pad coupling part is bent from an other side of the connecting portion toward the rear surface of the protruded portion of the brake pad, and
the body part is bent from the other side of the connecting portion connecting between the first arm and the second arm of the coupling part.

2. The retraction spring of claim 1, wherein the connecting portion connecting between the first arm and the second arm of the pad coupling part is positioned to face or contact a side surface of the protruded portion of the brake pad.

3. The retraction spring of claim 1, wherein the connecting portion connecting between the first arm and the second arm of the pad coupling part is positioned to face or contact a lower surface of the protruded portion of the brake pad.

4. The retraction spring of claim 2, wherein the body part extending from the pad coupling part has a first bent portion bent from the pad coupling part toward a center of the brake pad and a second bent portion bent away from the center of the brake pad.

5. The retraction spring of claim 4, wherein the body part extending from the pad coupling part further comprises a third bent portion bent in a direction substantially perpendicular to the brake pad to be connected to the carrier support part.

6. The retraction spring of claim 3, wherein the body part extending from the pad coupling part comprises a first bent portion bent upward from the pad coupling part and a second bent portion bent downward.

7. The retraction spring of claim 6, wherein the body part extending from the pad coupling part further comprises a third bent portion bent in a direction substantially perpendicular to the brake pad to be connected to the carrier support part.

8. The retraction spring of claim 1, wherein the first arm of the pad coupling part includes a first inclined portion bent from the one side of the connecting portion and inclined toward the second arm of the pad coupling part and a second inclined portion bent from the first inclined portion and inclined away from the second arm of the pad coupling part.

9. The retraction spring of claim 8, wherein the second arm of the pad coupling part includes a third inclined portion bent from the other side of the connecting portion and inclined toward the first arm of the pad coupling part and a fourth inclined portion bent from the third inclined portion and inclined away from the first arm of the pad coupling part.

10. The retraction spring of claim 1, wherein a closest distance between the first arm and the second arm of the pad coupling part is smaller than a thickness of the protruded portion of the brake pad.

11. The retraction spring of claim 1, wherein the body part extending from the pad coupling part has at least one opening.

12. The retraction spring of claim 1, wherein the carrier support part includes:
a first leg extending from the body part and bent in one direction; and
a second leg extending from the body part and bent in another direction different from the one direction in which the first leg is bent.

13. The retraction spring of claim 1, wherein the carrier support part includes:
a first leg extending from the body part and having a shape of being at least partially cut and bent in one direction; and
a second leg extending from the body part and bent in another direction different from the one direction in which the first leg is bent.

14. The retraction spring of claim 1, wherein the carrier support part includes at least one bent portion extending and bent from the body part extending from the pad coupling part.

15. A caliper brake comprising:
a pair of brake pads configured to be movable with respect to a rotor and having protruded portions protruding from sides of the brake pads;
a carrier including slide grooves in which the protruded portions of the brake pads are movably disposed and coupling hooks formed around the slide grooves; and
a retraction spring coupled to one of the protruded portions of the brake pads and configured to return one of the brake pads during an operation of brake release,
wherein the retraction spring includes:
a pad coupling part coupled to the one of the protruded portions of the brake pads, the pad coupling part including a first arm and a second arm supporting a front surface and a rear surface of the one of the protruded portions of the brake pads, respectively, and a connecting portion connecting between the first arm and the second arm and disposed to face a side or lower surface of the one of the protruded portions of the brake pads;
a body part extending from the pad coupling part and configured to provide an elastic restoring force; and
a carrier support part extending from the body part and supported by one of the coupling hooks,
the first arm of the pad coupling part is bent from one side of the connecting portion toward the front surface of the one of the protruded portions of the brake pads,
at least a portion of the second arm of the pad coupling part is bent from an other side of the connecting portion toward the rear surface of the one of the protruded portions of the brake pads, and
the body part is bent from the other side of the connecting portion connecting between the first arm and the second arm of the coupling part.

16. The caliper brake of claim 15, wherein the body part extending from the pad coupling part includes a first curved portion bent from the pad coupling part toward a center of the brake pads, a first flat portion extending from the first curved portion, a second curved portion bent from the first flat portion in a direction of being away from the center of the brake pads, and a second flat portion extending from the second curved portion.

17. The caliper brake of claim 16, wherein the body part further includes a third curved portion bent from the second flat portion in a direction substantially perpendicular to the brake pads, and a third flat portion extending from the third curved portion and connected to the carrier support part.

18. The caliper brake of claim 15, wherein the body part includes a first curved portion bent upward from the pad coupling part, a first flat portion extending from the first curved portion, a second curved portion bent downward from the first flat portion, and a second flat portion extending from the second curved portion.

19. The caliper brake of claim 18, wherein the body part further includes a third curved portion bent from the second flat portion in a direction substantially perpendicular to the brake pads, and a third flat portion extending from the third curved portion and connected to the carrier support part.

20. The caliper brake of claim 15, wherein the carrier is configured such that a distance from the rotor to the coupling hooks in which the protruded portions of one of the pair of brake pads are disposed is different from a distance from the rotor to the coupling hooks in which the protruded portions of another of the pair of brake pads are disposed.
